(19) United States
(12) Patent Application Publication
(10) Pub. No.: US 2009/0142950 A1
(43) Pub. Date: Jun. 4, 2009

(54) CABLE CONNECTION TO A SUBMERSIBLE PUMP

(76) Inventors: Tobias Schimmele-Brell, Weinstadt (DE); Mauro Marchesi, Pero (IT); Claudio Menegon, Rho (IT); Stefano Izzo, Caronno-Pertusella (IT); Claudio Boarolo, Rho (IT); Jan Strom, Sollentuna (SE)

Correspondence Address: LEON D. ROSEN;FREILICH, HORNBAKER & ROSEN, 10960 Wilshire Blvd., Suite 1220, Los Angeles, CA, 90024, US

(21) Appl. No.: 12/355,455

(22) Filed: Jan. 16, 2009

Related U.S. Application Data
(63) Continuation-in-part of application No. PCT/EP2007/000815, filed on Jun. 30, 2007.

(30) Foreign Application Priority Data
Jul. 26, 2006 (DE) 20 2006 011 700.8

(51) Int. Cl. H01R 13/52

(52) U.S. Cl. 439/271

(57) ABSTRACT

A device (10) for supplying electrical power and signals to a submersible pump (15) in such a way that it is sealed from liquids via an external electrical cable (11) extending through a opening (49) within the head (48) of a pump housing (50). The device comprises a plug connector device (10), whose pump-side plug connector part (13) is arranged within the through opening (49) of the housing head (48) so as to be axially movable and whose cable-side plug connector part (12) is provided with an insulation coating (25), which extends from an area of the cable jacket (20) down to its plug connector contacts (17), and about which, behind its free end, a coupling part (27) is provided which can be connected in a mechanically fixed manner to a counterpart coupling part (54) on the exterior end of the through opening (49) within the head (48) of the pump housing (50).

### CROSS-REFERENCE TO RELATED APPLICATION

This is a continuation-in-part of PCT/EP2007/005815 filed 30 Jun. 2007 which claimed priority from German application 20 2006 011 700.8 filed 26 Jul. 2006.

### BACKGROUND OF THE INVENTION

The present invention relates to a device for supplying electrical power and/or control signals to a submersible pump in such a way that it is sealed off from liquids.

In submersible pumps, all cables, such as the voltage supply cable, the cable that is connected to a float switch, and the like, are usually routed through a feed through that is filled with a sealing means directly into the interior of the pump housing, and the cable is connected to the relevant electrical components. According to contemporary notions, this represents the most cost-effective and simplest provision of electrical power and/or control signals that is sealed off from liquids.

However, submersible pumps of this type are generally subject to rough treatment, whether they are used underground, by a fire department or other helping organizations, in the private sector, in industry, or the like. Therefore, it happens again and again that the cables or the line itself may be damaged or even severed upstream of, or at, the area where they discharge into the housing head of the pump housing, so that liquid is able to penetrate into the pump housing via the interior of the cable and to damage the electrical components. Then the entire submersible pump must be returned to the manufacturer and repaired at considerable expense, because the housing head that is connected to the pump housing so as to be sealed off from liquids must be removed, replaced, and provided with a new cable. Since this cannot be done on site, an expensive replacement device must be used for an often relatively long period of time.

The objective of the present invention is therefore to indicate a device for supplying electrical power and/or control signals to a submersible pump of the type mentioned above so as to be sealed off from liquids, in which, when a supply cable is damaged, repairs can be carried out significantly more rapidly and even on site, and in which at the same time, when damage of this type occurs, moisture is prevented from penetrating via the cable into the interior of the pump housing.

### SUMMARY OF THE INVENTION

As a result of the measures provided by the present invention, the supply cable is arranged on the exterior of the pump housing in such a way that it is removable, so that, if the supply cable is damaged, it can be replaced through a simple exchange. The replacement can be accomplished using conventional tools and in a simple manner by moving the plug connector part on the pump side from the feed through to the outside in order to decouple or couple the plug connector device. In addition, the cable-side plug connector part may be configured both in itself and in cooperation with the pump-side plug connector part within the feed through, such that, if the cable is damaged or ruptured, no moisture or water is able to penetrate through the still-mounted plug connector and the feed through into the pump housing.

In accordance with the features of Claim 2, the plug connection of both plug connector parts, which is accomplished outside the pump housing, is further assured even after the pump-side plug connector part is returned to the feed through and after the cable-side plug connector part is coupled to the pump housing head, because the pump-side plug connector part is axially pressed against the feed.

In the plugged-in state and when the plug connection is attached to the pump housing, a further improvement of the seal towards the outside is indicated in accordance with the features of Claim 3.

The features in accordance with Claim 4 are provided in accordance with a first exemplary embodiment of a plug connection of this type between the cable and the submersible pump. Further improvements with regard to the seal of the cable-side plug connector part are yielded from the features of one or more of Claims 5 to 7. According to the features in accordance with Claim 6, a kind of vulcanization is achieved between the cable jacket and the insulation coating.

An advantageous design configuration is indicated in accordance with the features of Claim 8.

The features in accordance with Claim 9 achieve a simple seal between the two plug connector parts.

The features in accordance with Claim 10 are provided in accordance with a second exemplary embodiment of a plug connection of this type. This embodiment essentially facilitates the application to large-scale pumps that are driven in a three-phase manner and that are very heavy.

Advantageous configurations for this purpose are yielded from the features of one or more of Claims 11 to 19 with respect to the cable-side plug connector part and in accordance with the features of Claim 20 with regard to the pump-side plug connector part.

Further details of the present invention can be derived from the following description, in which the invention is described in greater detail and is discussed on the basis of the exemplary embodiments depicted in the drawing.

### DESCRIPTION OF THE DRAWINGS

FIG. 1 in a longitudinal cutaway representation along the line I-I of FIG. 2A, depicts a cable-side plug connector part of a plug connector device for submersible pumps according to a first exemplary embodiment of the present invention.

FIGS. 2A and 2B depict a front view of the cable-side plug connector part in accordance with FIG. 1 or a pump-side plug connector part that is fitted for insertion in the former in accordance with FIG. 3.

FIG. 3 depicts a sectional view along the line III-III of FIG. 2B through the pump-side plug connector part.

FIG. 4 in a cutaway representation, i.e., in segments, and in a sectional view along the cutaway line IVA-IVA of FIG. 2A or IVB-IVB of FIG. 2B, depicts the plug connector device in the plugged-in state in accordance with the first exemplary embodiment of the present invention.

FIG. 5 in a longitudinal-cutaway representation along the line V-V of FIG. 6A, depicts a cable-side plug connector part of a plug connector device for submersible pumps in accordance with a second exemplary embodiment of the present invention.

FIGS. 6A and 6B depict a front view of the cable-side plug connector part in accordance with FIG. 5 or a pump-side plug connector part that is fitted for insertion in the former in accordance with FIG. 7.

FIG. 7 depicts a sectional view along line VII-VII of the FIG. 6B through the pump-side plug connector part.

FIG. 8 in a cutaway representation, i.e., in segments, and in a sectional view, depicts the joined-together plug connector device consisting of the cable-side plug connector part in accordance with FIG. 5 and the pump-side plug connector part in accordance with FIG. 7 for submersible pumps in accordance with the second exemplary embodiment of the present invention.

### DESCRIPTION OF THE INVENTION

Plug connector devices 10 and 110 depicted in the drawing are used in submersible pumps for power and/or control cables 11, and they are configured for both design and assembly purposes such that no moisture from outside can penetrate into submersible pump 15, 115, when it is submerged, i.e., underwater, even if cable 11 of a cable-side plug connector part 12, 112 that is connected to a pump-side plug connector part 13, 113, is defective.

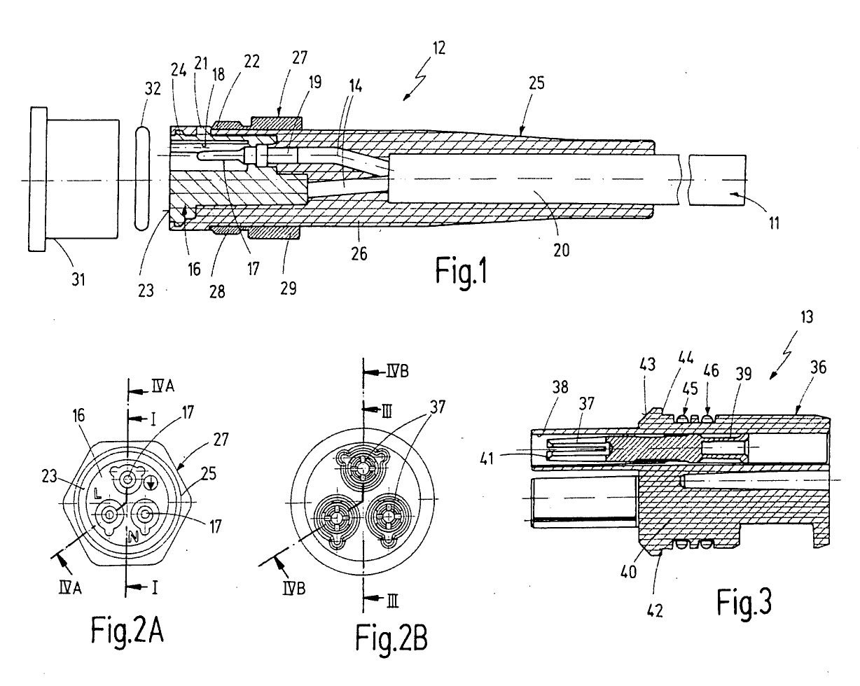

FIGS. 1 to 4 indicate a three-pole plug-connector device 10 in accordance with the first exemplary embodiment of the present invention.

FIG. 1 shows cable-side plug connector part 12, which contains an insulation housing 16 for three plug contacts 17 that are provided in the arrangement shown in FIG. 2B and are here configured as pin contacts that are milled in one piece. For this purpose, insulation housing 16 for each plug contact 17 has a stepped, axial through borehole 18, in the front area of which the pin of the plug contact 17 is arranged in the plug-in direction, in whose central area, of a smaller diameter, the plug contact is held axially pressed against a collar, and in whose rear area is located a crimping sleeve 19 of plug contact 17, each said crimping sleeve fixedly connecting to a conductor 14 of cable 11 both electrically and mechanically. On the exterior periphery, insulation housing 16 is provided with protrusions 21, which are arranged so as to be distributed over a ring-shaped peripheral area whose exterior diameter is greater than the exterior circumference of insulation housing 16, said protrusions being attached to the rear end and thus bordering a shoulder 22 that points towards cable 11. Protrusions 21 are arranged in an axial plane in which are located the front, free ends of plug contacts 17. Between an end face 23 of insulation housing 16 and protrusions 21, a ring 24 is provided whose exterior diameter is somewhat smaller than that of protrusions 21.

Insulation housing 16 from the plane of its end face 23 is spray-coated with a plastic or rubber jacket 25 so as to be sealed off from moisture, said jacket extending past conductors 14 and an axial area of jacket 20 of cable 11, as can be seen in FIG. 1. Rubber jacket 25 also surrounds crimping sleeve 19 of plug contacts 17 that are connected to conductors 14, so that plug contacts 17 are axially fixed in both directions. At the periphery of rubber jacket 25, protrusions 21 are visible on the exterior periphery. By spray coating protrusions 21 and ring 24, the result is a fixing of insulation housing 16 in position within rubber jacket 25 both radially and peripherally, as well as an axial seal from cable-side plug connector part 12, even if insulation coating 25 becomes damaged in the area of cable 11. The material of cable jacket 20 is-chosen as the material of rubber sleeve 25, so that a kind of vulcanization is achieved with the spray coating.

The area 26 of rubber jacket 25, which surrounds the rear area in the plug-in direction of insulation housing 16 down to protrusions 21, is surrounded by an axially mobile “union” nut 21, which contacts a shoulder 22, because the exterior circumference of rubber jacket 25 in area 26 is smaller in diameter than the exterior diameter of protrusions 21. The exterior diameter of rubber jacket 25 also extends beyond the area of cable jacket 20 such that nut 27 continues to be movable in the longitudinal direction. Nut 27 has an exterior thread 28 in the front part in the plug-in direction as well as a hexagon lug 29 that is attached towards the rear, for example, to permit the use of a tool, in particular a wrench.

A dirt and dust cap 31 and a sealing ring 32 are provided for shipping cable-side plug connector part 12 along with a submersible pump 15. Inserting sealing ring 32 in between, dust cap 31 can be pushed over the part of cable-side plug connector part 12 that is at the front in the plug-in direction as well as over exterior thread 28 of union nut 27.

According to FIG. 3, pump-side plug connector part 13 has an insulation housing 36, in whose three axial through boreholes 38, which are arranged so as to be distributed over the circumference in a triangular shape, plug contacts 37 are arranged in the form of female contacts that are milled in one piece. These female contacts 37 at their rear end in the plug-in direction have a crimping sleeve 39, which is connected to the conductor of a cable in an undepicted manner, and at their front area in the plug-in direction, they have a bushing 41 having multiple axial slots for receiving pin contacts 17. The central area of plug contact 37 is axially held by being pressed within insulation housing 36 in a manner that is not depicted in detail. Through boreholes 38, which are formed in the rear area in the plugin direction within a body 40 of insulation housing 36, are configured as sleeve-shaped in the front area in the plug-in direction, so that they fit into corresponding axial through boreholes 18 of insulation housing 16 of cable-side plug connector part 12.

Insulation housing 36 of pump-side plug connector part 13 at the end of body 40 that is facing bushings 41 is provided with an annular lug 42, whose front area in the plug-in direction forms a conical shoulder 43 and whose rear area in the plug-in direction is configured in a stepped manner for creating a shoulder 44. In connection with shoulder 44, the body of insulation housing 36 is provided with two adjoining annular grooves, into each of which an O-ring 45 or 46 is inserted.

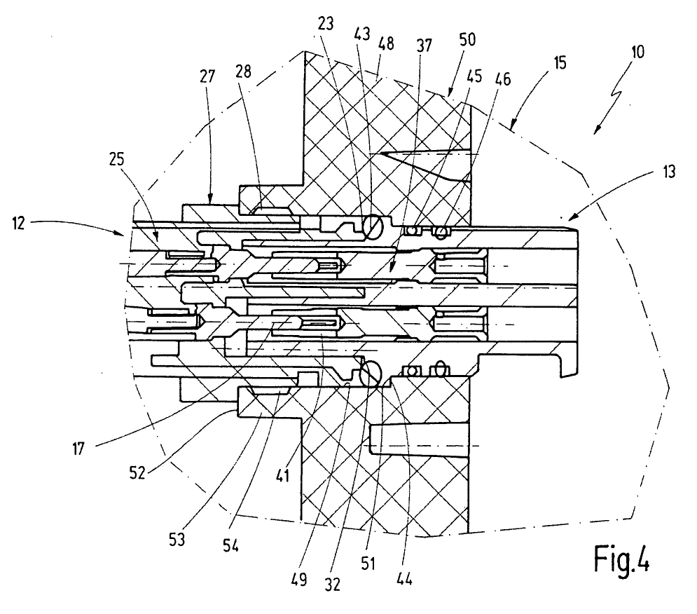

FIG. 4 indicates the arrangement of plug connector device 10, made up of joined plug connector parts 12 and 13 in and at head 48 of a pump housing 50. Head 48 of pump housing 50 is provided with a wall through opening 49, which is configured within housing head 48 in a stepped manner and thus forms an interior shoulder 51. Insulation housing 36 of pump-side plug connector part 13 is inserted from outside into through opening 49, after the ends of an undepicted cable protruding from housing head 48 have been connected to or crimped with plug contacts 37. In the plugged-in state, insulation housing 36 with its rear shoulder 44 contacts shoulder 51 within through opening 49. Both O-rings 45 and 46 seal insulation housing 36 in the direction of the interior of pump housing 50 behind shoulder 44 within through opening 48. The end faces of bushings 41 are located in the same plane within an extension lug 53 of through opening 49, which is provided with an interior thread 54 from the point of view of end face 52, into which, in the plugged-in state of cable-side plug connector part 12, can be screwed exterior thread 28 of “union” nut 27. In other words, after inserting cable-side plug connector part 12 into pump-side plug connector part 13 that is arranged within through opening 49, pin contacts 17 are inserted into sleeve contacts 37, and end face 23 of insulation housing 16 via sealing ring 32 contacts conical end face 43 of insulation housing 36. After fixing the screw connection between nut 27 and through opening 49, sealing ring 32 is crushed in such a way that it creates a seal both radially as well as axially. In the joined state of plug connector device 10, sealing ring 32 then prevents the penetration of moisture. In addition, rubber jacket 25 in this area is sealingly inserted into through opening 49.

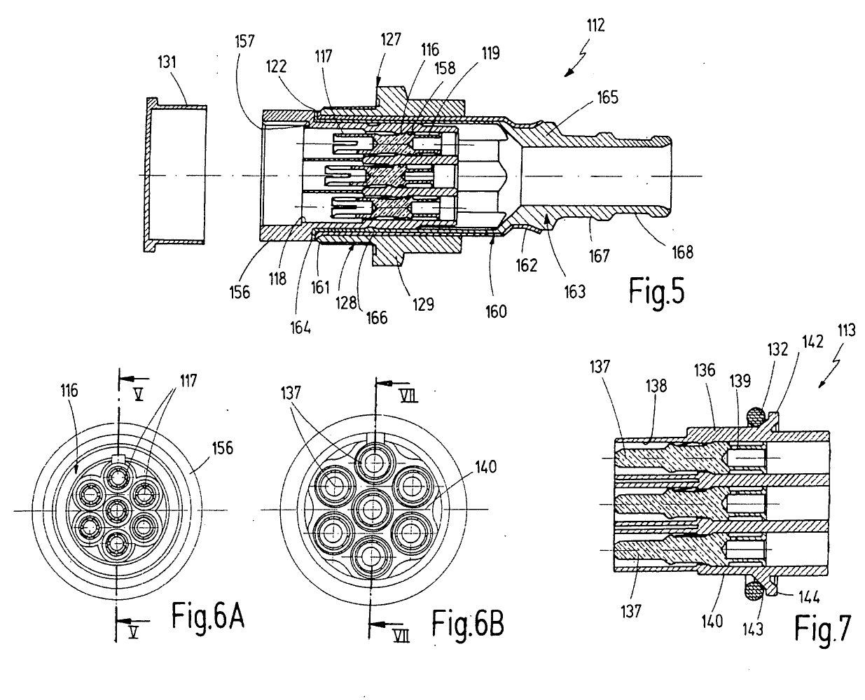

In plug connector device 110 according to a second exemplary embodiment, as depicted in FIGS. 5 to 8, a seven-pole arrangement of plug contacts 117 and 137 of cable-side plug connector part 112 and of pump-side plug connector part 113 is provided. In this context, plug contacts 117 of cable-side plug connector part 112 are configured as sleeve contacts, whereas plug contacts 37 of pump-side plug connector part 113 are configured as pin contacts.

According to FIG. 5, cable-side plug connector part 112 has an insulation housing 116, which for individually receiving plug contacts 117 is provided with corresponding through boreholes 118. In the depicted exemplary embodiment, insulation housing 116, which is made of a thermoplastic compound, for example, PBT, is provided with a sleeve-like lug 156, which has an exterior diameter that is greater than the exterior diameter of the remaining insulation housing 116 and which thus is furnished with a shoulder 122 in opposition to the plug-in direction. The interior diameter of sleeve lug 156 has an uninterrupted hollow space and is provided with an interior shoulder 157. Individual plug contacts 117 are held in stepped through boreholes 118 so as to be axially pressed in both directions. In addition, plug contact 117 at the transition from its central area towards crimping sleeve 119 has an annular groove, in which an O-ring 158 is provided for creating a seal within through opening 118.

The main, or body, area of insulation housing 116 is surrounded by a metal tube 160, whose front end 161 is bent in a flange-like manner and whose rear end is configured as a crease 162. Within this metal tube 160, which is preferably made of stainless-steel, a rubber protective sleeve 163 is injection molded or inserted, whose area traversing metal tube 160 terminates around flange end 161 as a further flange end 164 and whose rear area 165 is configured as a thickened area and functions as a through opening for an undepicted cable, which is connected to plug contacts 117 and which leads to insulation housing 116. Crease 162 functions to fix the undepicted cable in position, to relieve strain on it, as well as to axially fix insulation housing 116 in position. In addition, insulation housing 116 is axially fixed in position in that it has in its roughly axially central area an annular groove into which an interior annular bar 166 of rubber protective sleeve 163 locks in place during assembly. Here as well, if the undepicted cable is damaged, there is no possibility for moisture to penetrate from rubber protective sleeve 163 into the front plug-in area of cable-side plug connector part 112, especially if rubber protective sleeve 163 at rear areas 167, 168 is fixed in position about the cable jacket using undepicted pipe-clamp-like elements.

Surrounding metal tube 160 is a union nut 127, which also has a front exterior thread 128 and a rear hexagon lug 129 to enable a tool to be used. Union nut 127 can be displaced along metal tube 160 and, in the pushed-forward state, contacts front flange-like bent end 161 of metal tube 160. In the direction facing away from the plug-in direction, union nut 127 can move over the entire metal tube 160 and over the pipe-clamp-like connecting elements located around rear end 167, 168 of rubber protective sleeve 163, so that the insertion of insulation housing 116 at its plug contacts 117 into rubber protective sleeve 163 that surrounds metal tube 160 is not hindered.

FIG. 7 depicts pipe-side plug connector part 113 having its insulation housing 136, in whose through boreholes 138 plug contacts 137 are axially fixed in position and are held in place by being pressed in. Insulation housing 136 at one area of the rear end of crimping sleeve 139 is provided with an exterior annular lug 142, which in the plug-in direction has a conical shoulder 143 and in the reverse direction has a shoulder 144. Plug contacts 137, similar to plug contacts 37 in accordance with FIG. 3, are located in front within sleeves that protrude from body 140 of insulation housing 136.

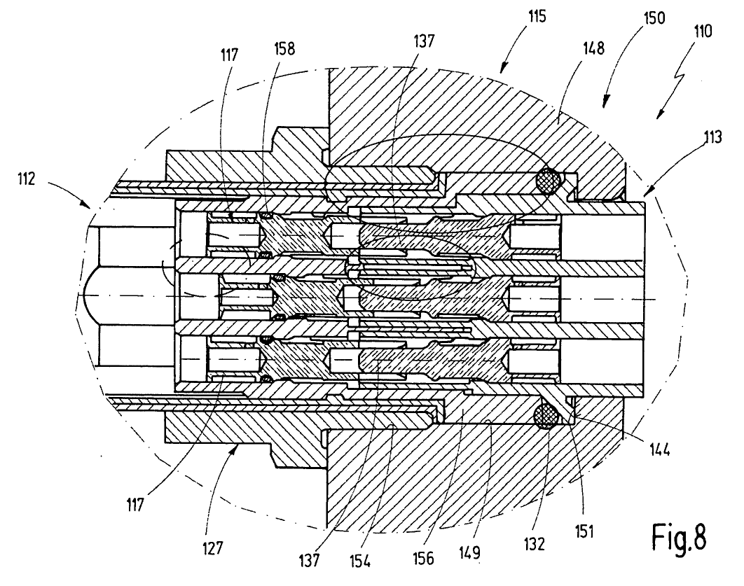

The arrangement of pump-side plug connector part 113 in a through opening 149 of a head 148 of a pump housing 150 can be seen from FIG. 8 and is designed in a manner similar to that of the first exemplary embodiment. Here as well, through opening 149 in housing head 148 has an interior shoulder 141 that is visible from the outside, which, in the plugged-in state, pump-side plug connector part 113 contacts at its shoulder 144.

In the front area, through opening 149 within housing head 148 has an interior threaded borehole 154, into which “union” nut 127 can be screwed with its exterior thread. In the plugged-in and screwed-in state, the annular end face of sleeve lug 156 presses via sealing ring 132 against conical shoulder 143, so that here as well an axial and radial seal of the plug connection is achieved within through opening 149.

In this exemplary embodiment as well, pump-side plug connector part 113 can be removed from through opening 149 from the outside and connected to the relevant electrical leads located within pump housing 50.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A device (10, 110) for supplying electrical power and/or control signals to a submersible pump (15, 115) in such a way that the pump is sealed off from liquids via an external electrical cable (11) that has a jacket (20) and that extends through a through opening (49, 149) within the head (48, 148) of a pump housing (50, 150) of the submersible pump (15, 115), wherein a plug connector device (10, 110) has a pump-side plug connector part (13, 113) arranged within a through opening (49, 149) of a housing head (48, 148) so as to be axially movable therein, the plug connector device also has a cable-side plug connector part (12, 112) that is provided with an insulation coating (25, 125) which extends from an area of the cable jacket (20) to plug connector contacts (17, 117), the plug connector part also having a coupling part (27, 127) which is mechanically connectable to a counterpart coupling part (54, 154) on the exterior of the through opening (49, 149) within the head (48, 148) of the pump housing (50, 150).

2. The device as recited in claim 1, wherein the pump-side plug connector part (13, 113) has a contact shoulder (44, 144) that protrudes radially beyond the exterior periphery of its insulation housing (36, 136) and that contacts a counterpart shoulder (57, 157) axially towards the interior within the through opening (49, 149), and, on a circumferential area that faces away from the contact shoulder (44, 144), the pump-side plug connector part is provided with an annular seal (32, 132), against which the cable-side plug connector part (12, 112) is pressed at the end face, in the assembled state of the plug connector device (10, 110).

3. The device as recited in claim 2, wherein the annular seal is an O-ring (32, 132), which contacts a conical annular surface (43, 143) of a closed shoulder ring (42, 142) that constitutes the contact shoulder (44, 144) and that faces away from the annular surface.

4. The device as recited in any of claims 1 to 3, wherein the insulation housing (16), receiving the plug connector contacts (17), of the cable-side plug connector part (12) is surrounded by the insulation coating (25) so as to be flush with its end face.

5. The device as recited in claim 4, wherein the insulation coating (25) surrounds the cable jacket (20), the individual conductors (14) of the cable (15), and partially a crimping connection of the individual conductors (14) in the relevant end (19) of the plug connector contacts (17).

6. The device as recited in claim 5, wherein the insulation coating (25) is made of the same material as the cable jacket (20).

7. The device as recited in any of claims 4 to 6, wherein the insulation housing (16) of the cable-side plug connector part (12) is provided with protrusions (21) on the exterior circumferential side which are entirely or partially surrounded by the insulation coating (25).

8. The device as recited in claim 7, wherein a part of the protrusions (21) function to provide the axial arrangement of the coupling part, which is configured as a nut (27) that is provided with an exterior thread.

9. The device as recited any of claims 4 to 8, wherein the insulation housing (36), receiving the plug connector contacts (37), of the pump-side plug connector part (113) facing away from its contact shoulder (44) is furnished on the exterior circumference side with an annular groove (45, 46) having an O-ring.

10. The device as recited in any of claims 1 to 3, wherein:
the insulation coating (125) is formed by a rubber protective sleeve (163), which is surrounded by a sleeve (160) that is made of metal, preferably stainless steel.

11. The device as recited in claim 10, wherein the rubber protective sleeve (163) extends beyond the end of the sleeve (160).

12. The device as recited in claim 11, wherein the sleeve (160) is provided with a flange-like, bent end face (161).

13. The device as recited in any of claims 10 to 12, wherein the sleeve (160), at its end facing away from the end face (161) in the area of the transition from the receptacle of the insulation housing (136) for the plug connector contacts (137) to the cable that is provided with a jacket, is provided with a circumferential-side crease (162).

14. The device as recited in any of claims 10 to 13, wherein the rubber protective sleeve (163) is injected molded, or assembled, along the interior circumference of the sleeve (160).

15. The device as recited in any of claims 10 to 14, wherein the coupling part that is provided as an exterior threaded nut (127) comes into contact with the flange-like end face (161) of the sleeve (160).

16. The device as recited in any of claims 10 to 15, wherein the insulation housing (116), receiving the plug connector contacts (117), of the cable-side plug connector part (112) has an axial extension sleeve (156) that has a larger exterior diameter, at whose exterior shoulder the sleeve (160) makes contact via the rubber protective sleeve (163).

17. The device as recited in claim 16, wherein, in the plugged-in state, an axial shoulder (144) on the insulation housing (136) of the pump-side plug connector part (113) comes into contact with the interior shoulder (157) of the extension ring (156).

18. The device as recited in claim 16, wherein the insulation housing (136) is made of a thermoplastic compound, preferably PBT.

19. The device as recited in any of claims 10 to 18, wherein the insulation housing (136) is provided with an annular groove on its exterior circumference side, in which an interior annular lug in the rubber protective sleeve (163) can latch.

20. The device as recited in any of claims 10 to 19, wherein the plug connector contacts (117), which are received in the insulation housing (116) of the cable-side plug connector part (112) so as to be able to be axially plugged in, are furnished with an axially retained O-ring.
